(19) United States
(12) Patent Application Publication
(10) Pub. No.: US 2016/0210944 A1
(43) Pub. Date: Jul. 21, 2016

(54) Electronic Cowbell

(71) Applicant: Al-Musics Technology Inc., New Taipei City (TW)

(72) Inventor: Gwo-Hsiung Wei, New Taipei City (TW)

(21) Appl. No.: 14/598,748

(22) Filed: Jan. 16, 2015

(51) Int. Cl. G10D 13/06

(52) U.S. Cl. CPC G10D 13/06

(57) ABSTRACT

Various implementations of an electronic cowbell are provided. In one aspect, an electronic cowbell may include a main holder, a first sensor, a second sensor, an elastic pad, and a back cover. The first sensor may be disposed on a first portion of the main holder. The second sensor may be disposed on a second portion of the main holder. The elastic pad may be disposed on the main holder. The first sensor and the second sensor may be configured to detect percussions of multiple percussion zones of the main holder. The back cover and the main holder may be coupled together to form an enclosure that contains either or both of the first sensor and the second sensor therein.

### TECHNICAL FIELD

The present disclosure relates to the field of electronic musical instruments and, more particularly, to electronic percussion instruments.

### BACKGROUND

Unless otherwise indicated herein, approaches described in this section are not prior art to the claims listed below and are not admitted to be prior art by inclusion in this section.

There are various types of electronic musical instruments including electronic percussion instruments, such as an electronic cowbell. A conventional cowbell, used as a musical instrument, is typically made of thin, flat piece(s) of sheet metal. The size and shape of the cowbell, as well as the thickness of the sheet metal, affect the sound generated by the cowbell. An electronic cowbell is an electronic percussion instrument designed to produce sounds resembling those of a conventional cowbell.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure provides various implementations of an electronic percussion instrument, such as an electronic cowbell. An electronic cowbell in accordance with the present disclosure includes two percussion zones, and does not have a round or oval cross-sectional shape when viewed along a longitudinal axis thereof. The electronic cowbell in accordance with the present disclosure is designed to have the same percussion areas and percussion position(s) as those of conventional cowbells, and has a size approximately the same as a conventional cowbell. Additionally, the electronic cowbell in accordance with the present disclosure may be used in conjunction with other percussion instrument such as, for example, a drum pad or drum set. Moreover, the electronic cowbell in accordance with the present disclosure is designed to have approximately the same structure to clamp to conventional hardware and accessories for ease of replacement of a conventional cowbell, and thus may be set up anywhere a conventional cowbell could be set up.

In one aspect, an electronic cowbell may include a main holder, a first sensor, a second sensor, an elastic pad, and a back cover. The first sensor may be disposed on a first portion of the main holder. The second sensor may be disposed on a second portion of the main holder. The elastic pad may be disposed on the main holder. The first sensor and the second sensor may be configured to detect percussions of multiple percussion zones of the main holder. The back cover and the main holder may be coupled together to form an enclosure that contains either or both of the first sensor and the second sensor therein.

In at least some implementations, the first sensor may be disposed on a first side of the main holder, and the second sensor may be disposed on a second side of the main holder opposite the first side thereof.

In at least some implementations, the first sensor may be disposed between the main holder and the elastic pad.

In at least some implementations, the first sensor may be a sheet sensor, and the second sensor may be a piezoelectric sensor.

In at least some implementations, the main holder may be made of a plastic material, a die-cast material or a steel plate.

In at least some implementations, the elastic pad may be made of rubber, silicone, plastic, or a combination thereof.

In at least some implementations, the back cover may be made of a plastic material, a die-cast material or a steel plate.

In at least some implementations, the back cover may include one or more holes that reduce generation of resonance sound in response to percussion of the main holder.

In at least some implementations, the electronic cowbell may further include a circuit board and a circuit board holder. The circuit board may be electrically connected to the first sensor and the second sensor. The circuit board may be disposed on the circuit board holder.

In at least some implementations, the circuit board holder may be mounted on the main holder.

In at least some implementations, the circuit board holder may be made of a plastic material.

In at least some implementations, the electronic cowbell may further include a shaft holder, a fixing screw and a wing nut. The shaft holder may be coupled to the main holder, and may include one or more holes. The fixing screw may include a loop. The wing nut may be configured to secure the shaft holder between the fixing screw and the wing nut. The fixing screw and shaft holder may be configured to install the electronic cowbell on a shaft with the shaft traversing through the loop of the fixing screw and the one or more holes of the shaft holder.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a first perspective view of an electronic cowbell in accordance with an implementation of the present disclosure.

FIG. 2 is a second perspective view of an electronic cowbell in accordance with an implementation of the present disclosure.

FIG. 3 shows various plane views of an electronic cowbell in accordance with an implementation of the present disclosure.

FIG. 4 is an exploded view of an electronic cowbell in accordance with an implementation of the present disclosure.

FIG. 5 is a cross-sectional view of an electronic cowbell in accordance with an implementation of the present disclosure.

FIG. 6 is another cross-sectional view and partial enlarged view of an electronic cowbell in accordance with an implementation of the present disclosure.

FIG. 7 is yet another cross-sectional view and partial enlarged view of an electronic cowbell in accordance with an implementation of the present disclosure.

FIG. 8 shows additional various views of an electronic cowbell in accordance with an implementation of the present disclosure.

FIG. 9 shows an electronic cowbell in accordance with an implementation of the present disclosure mounted on conventional hardware.

### DETAILED DESCRIPTION OF PREFERRED IMPLEMENTATIONS

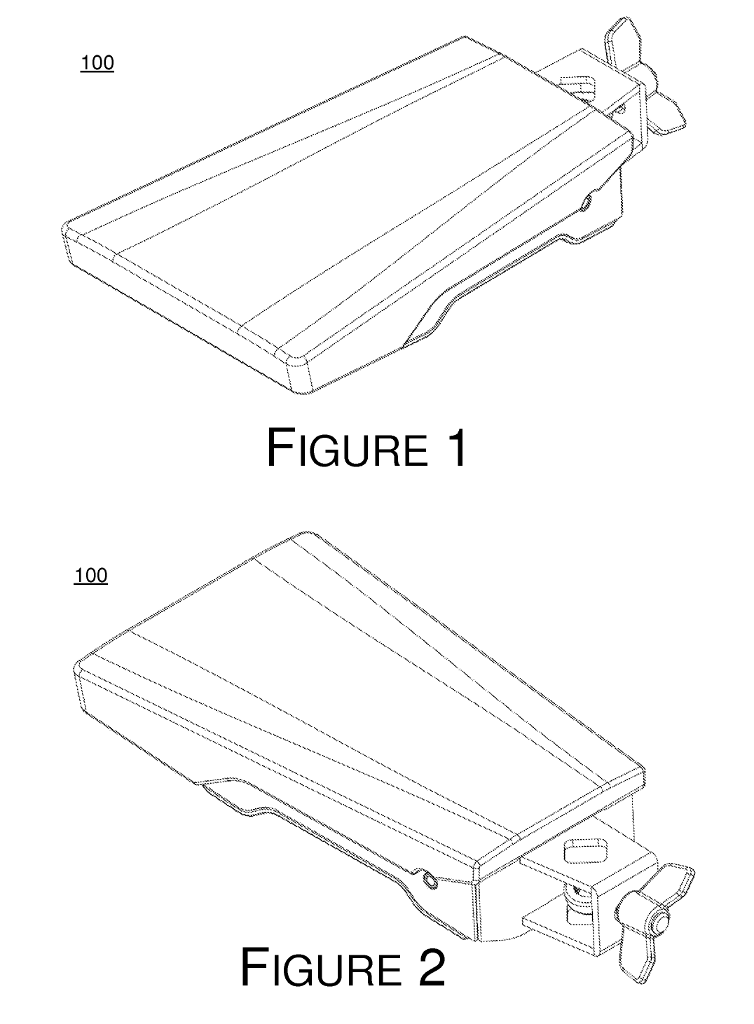

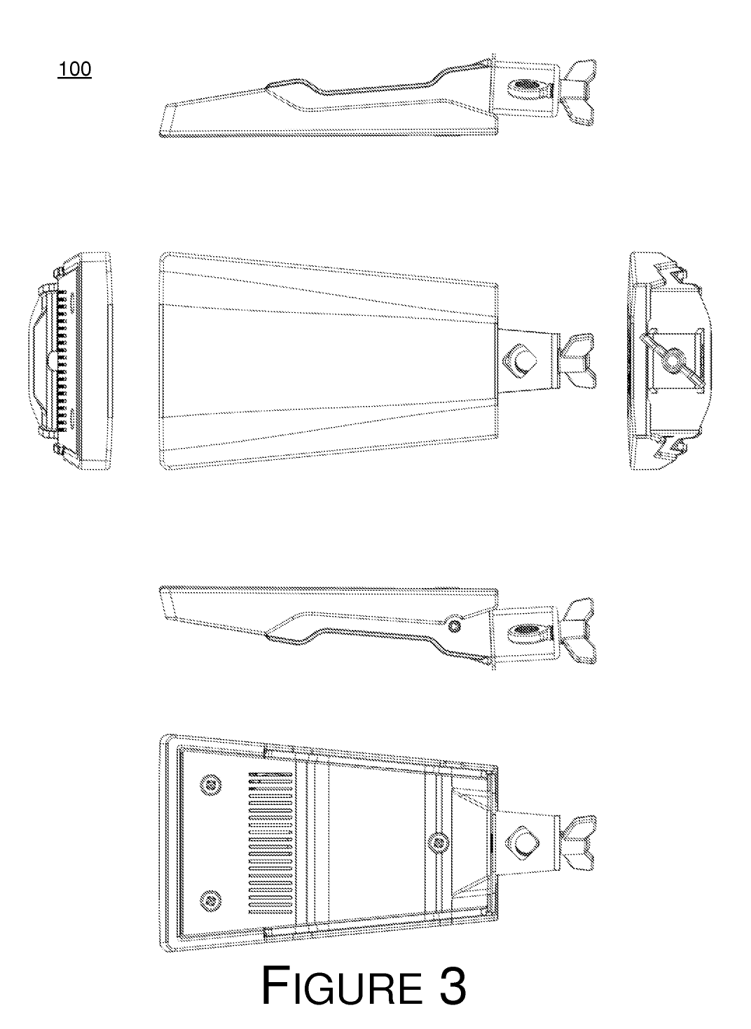

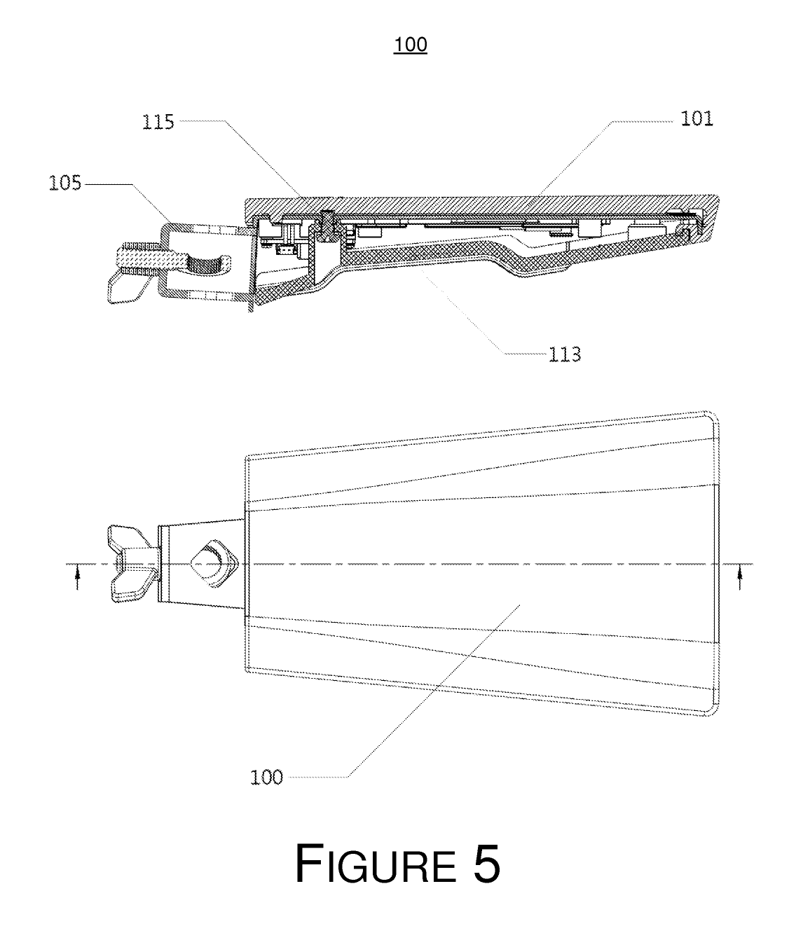

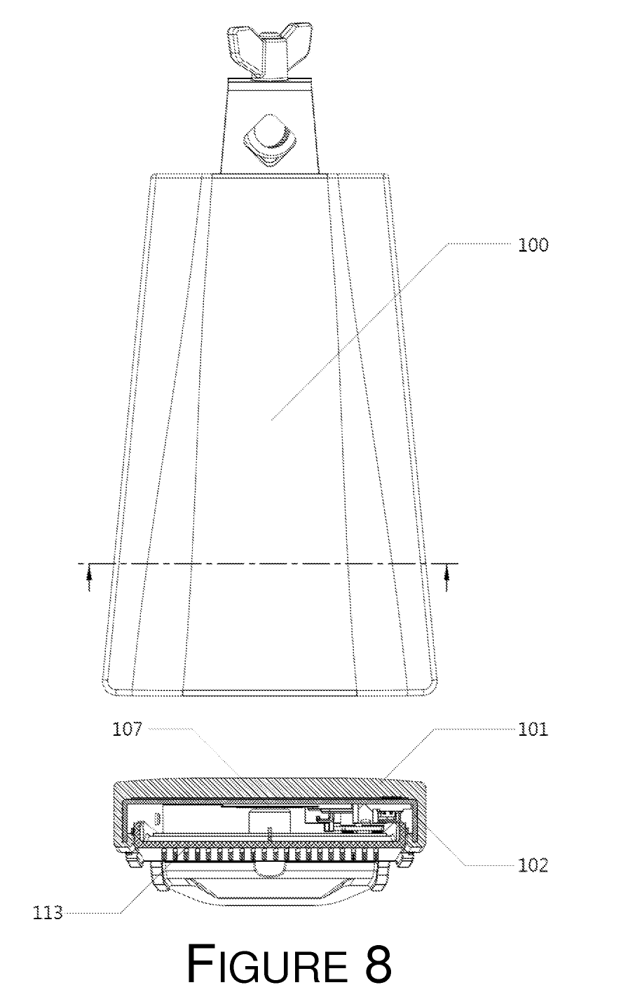

FIGS. 1-9 are various views of an electronic cowbell 100 in accordance with an implementation of the present disclosure. Description below regarding electronic cymbal assembly 100 is made with reference to FIGS. 1-9.

Electronic cowbell 100 is designed with multiple percussion zones or portions such as, for example, Zone 1 and Zone 2. Zone 1 may be referred to as the “edge zone” or “edge” herein and Zone 2 may be referred to as the “top zone” or “top” herein. The term “zone” may be interchangeably referred to as “portion” herein. Likewise, the term “zones” may be interchangeably referred to as “portions” herein. With this design, an electronically-simulated sound that resembles the percussion of a conventional cowbell may be generated by electronic cowbell 100 when any one of the multiple percussion zones is percussed by a user. More specifically, an electronically-simulated sound resembling the percussion of the edge portion of a conventional cowbell may be generated by electronic cowbell 100 when Zone 1 of electronic cowbell 100 is percussed by the user. Similarly, an electronically-simulated sound resembling the percussion of the top portion of a conventional cowbell may be generated by electronic cowbell 100 when Zone 2 of electronic cowbell 100 is percussed by the user.

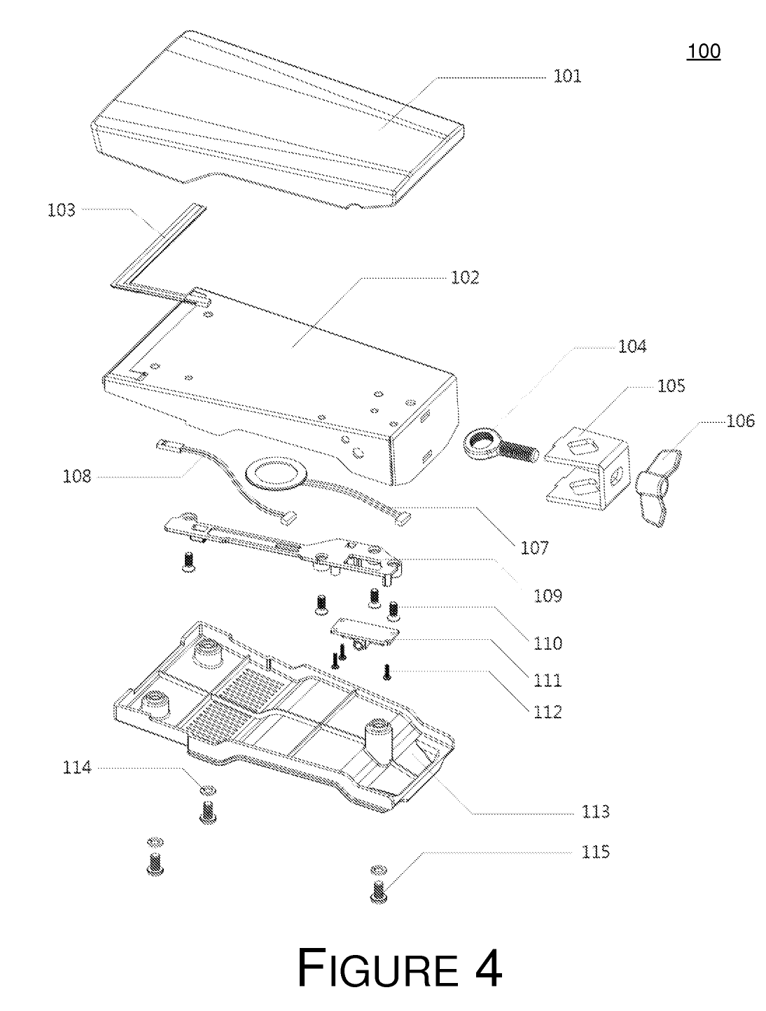

As shown in detail in FIG. 4, in some implementations, electronic cowbell 100 may be constructed with components including the following: an elastic pad 101, a main holder 102, an edge zone sensor 103, a fixing screw 104, a shaft holder 105, a wing nut 106, a top zone sensor (and connection cable) 107, an edge zone sensor cable 108, a circuit board holder 109, one or more circuit board holder fixing screws 110, a circuit board 111, one or more circuit board fixing screws 112, a back cover 113, one or more spring washers 114, and one or more back cover fixing screws 115. Each of edge zone sensor 103 and top zone sensor 107 may be a sheet sensor or a piezoelectric sensor. Circuit board 111 is electrically connected to edge zone sensor 103 and top zone sensor 107 to receive electrical signals from each of edge zone sensor 103 and top zone sensor 107 in response to one or more of edge zone sensor 103 and top zone sensor 107 detecting percussion(s) of one or more percussion zones of main holder 102 (through elastic pad 101) by a user.

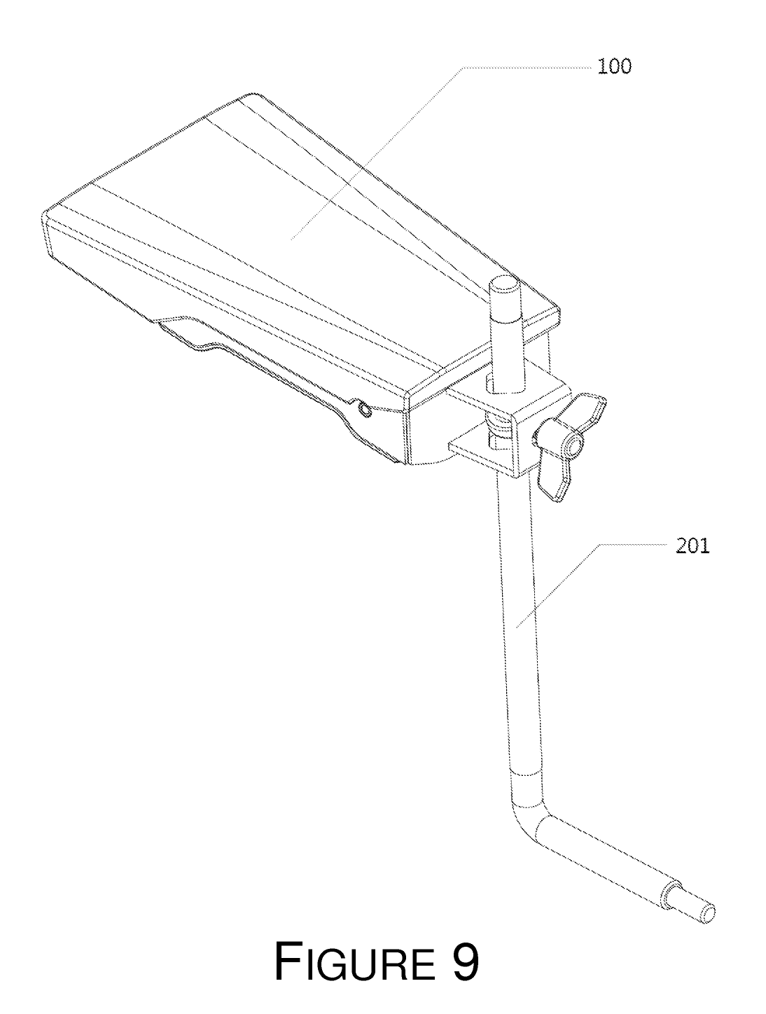

As shown in FIG. 9, wing nut 106 may be screwed onto fixing screw 104 through an opening of shaft holder 105, with shaft holder 105 being between fixing screw 104 and wing nut 106. Fixing screw 104 may include a loop and shaft holder 105 may include opening(s) thereon as well. In the example shown in FIG. 9, the combination of fixing screw 104, shaft holder 105 and wing nut 106 may install, mount or otherwise secure electronic cowbell 100 onto a shaft 201 of conventional hardware of a drum set. For example, shaft 201 may traverse through the loop of fixing screw 104 as well as the opening(s) on shaft holder 105 when electronic cowbell 100 is installed, mounted or otherwise secured onto shaft 201.

In some implementations, elastic pad 101 may be made of an elastic material such as, for example, rubber, silicone, plastic, etc. or a combination thereof. Accordingly, elastic pad 101 is designed to allow electronic cowbell 100 to make low-sound when being percussed, thereby allowing electronic cowbell 100 to be played by the user anytime without making loud sound.

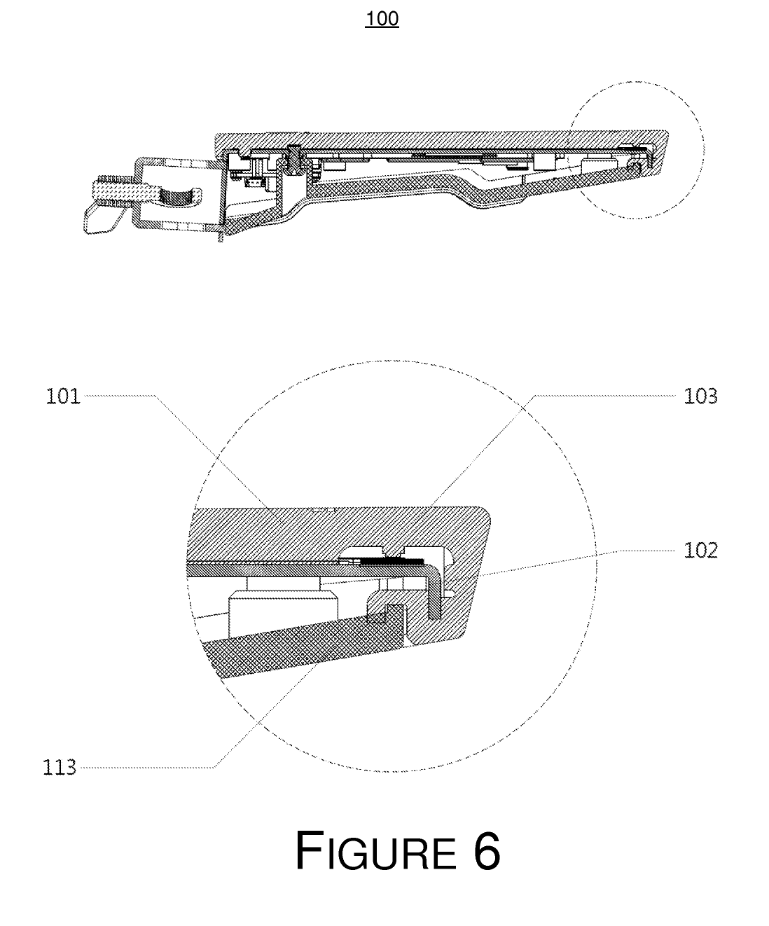

In some implementations, edge zone sensor 103 may be a sheet sensor, and may be installed on, mounted on, adhered to or otherwise affixed on a front edge of main holder 102. As shown in FIG. 6, edge zone sensor 103 may be disposed between main holder 102 and elastic pad 101. When the edge of electronic cowbell 100 is percussed by the user, elastic pad 101 will contact edge zone sensor 103 which will in turn generate a first electrical signal. Circuit board 111 is configured to receive the first electrical signal from edge zone sensor 103 via edge zone sensor cable 108, and is configured to provide a first sound electrical signal configured to generate an electronic percussion sound, e.g., via one or more speakers.

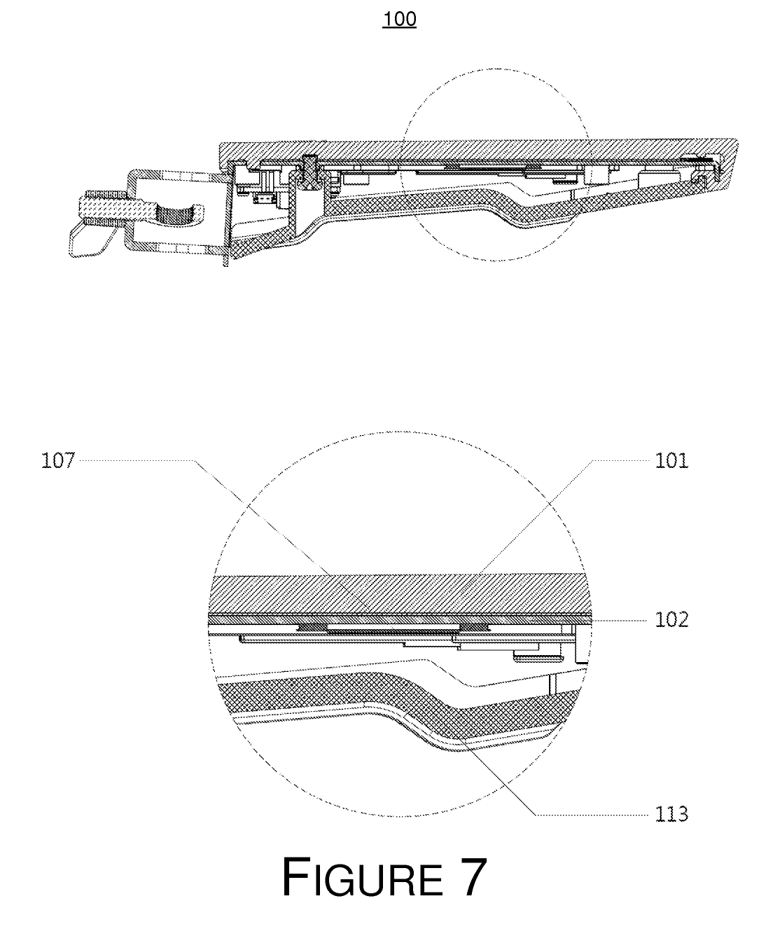

In some implementations, top zone sensor 107 may be a piezoelectric sensor, and may be installed on, mounted on, adhered to or otherwise affixed on an inside of main holder 102. As shown in FIG. 7, top zone sensor 107 may be disposed on an inner side of main holder 102 opposite an external side of main holder 102 which is in contact with elastic pad 101. Accordingly, top zone sensor 107 is configured to detect percussions on various portions of elastic pad 101. For example, when the top portion of electronic cowbell 100 is percussed by the user, top zone sensor 107 will generate a second electrical signal. Circuit board 111 is configured to receive the second electrical signal from edge zone sensor 103, and is configured to provide a second sound electrical signal configured to generate an electronic percussion sound, e.g., via one or more speakers.

In some implementations, main holder 102 may be made of a sheet plate. In some implementations, main holder 102 and shaft holder 105 may be coupled, connected, bonded, secured or otherwise joined together by welding. Each of main holder 102 and shaft holder 105 may be made of a material that includes plastic or die-cast material, e.g., metal, or a steel plate. In some implementations, main holder 102 and elastic pad 101 may be coupled, connected, bonded, secured or otherwise joined together by double-sided tapes or an adhesive material. Main holder 102 may include multiple percussion zones or portions that correspond to the multiple percussion zones or portions of electronic cowbell 100. That is, when one of the percussion zones or portions of main holder 102 is percussed (through elastic pad 101) by a user, either or both of edge zone sensor 103 and top zone sensor 107 may detect the percussion. Similarly, when another percussion zone or portion of main holder 102 is percussed (through elastic pad 101) by the user, either or both of edge zone sensor 103 and top zone sensor 107 may detect the percussion. In any case, in the event that both of edge zone sensor 103 and top zone sensor 107 detect the percussion when one of the percussion zones or portions is percussed, the electrical signal thus generated by edge zone sensor 103 and top zone sensor 107 are different due to, for example, a distance between the point of percussion and each of edge zone sensor 103 and top zone sensor 107.

In some implementations, circuit board holder 109 may be made of a plastic material, and may be coupled, connected, bonded, secured or otherwise joined to main holder 102 by one or more circuit board holder fixing screws 110. Circuit board 111 may be coupled, connected, bonded, secured or otherwise joined to circuit board holder 109 by one or more circuit board fixing screws 112.

In some implementations, back cover 113 may be made of a plastic material. Alternatively, back cover 113 may be made of a material that includes plastic or die-cast material, e.g., metal, or a steel plate. For example, back cover 113 may be made of a steel plate. Back cover 113 may be secured onto main holder 102 by one or more spring washers 114 and one or more back cover fixing screws 115. In some implementations, back cover 113 may include one or more holes. The one or more holes help avoid the generation of excessive resonance sound, which is undesirable, inside electronic cowbell 100. That is, the one or more holes on back cover 113 help reduce the generation of resonance sound in response to percussion of main holder 102 (through elastic pad 101).

In some implementations, electronic cowbell 100 may have a cross-section across a longitudinal axis thereof that is not round or oval. Electronic cowbell 100 is designed to keep the shape and size of a conventional cowbell, and electronic cowbell 100 may be set up anywhere and played like a conventional cowbell.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations.

Furthermore, in those instances where a convention analogous to “at least one of A, B, and C, etc.” is used, in general such a construction is intended in the sense one having skill in the art would understand the convention, e.g., “ a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “ a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. An electronic cowbell, comprising:
a main holder;
a first sensor disposed on a first portion of the main holder;
a second sensor disposed on a second portion of the main holder;
an elastic pad disposed on the main holder; and
a back cover,
wherein the first sensor and the second sensor are configured to detect percussions of multiple percussion zones of the main holder,
wherein the back cover and the main holder are coupled together to form an enclosure that contains the second sensor therein with the first sensor outside of the enclosure,
wherein the first sensor is disposed on a first side of the main holder facing away from the back cover such that the first sensor is disposed between the main holder and the elastic pad,
wherein the second sensor is disposed on a second side of the main holder which is opposite the first side of the main holder and facing toward the back cover, and
wherein each of a shape of the main holder, a shape of the elastic pad and a shape of the back cover is substantially trapezoidal viewed from an angle such that the a shape of the electronic cowbell resembles a shape of a conventional cowbell.

2. (canceled)

3. (canceled)

4. The electronic cowbell of claim 1, wherein the first sensor is a sheet sensor, and wherein the second sensor is a piezoelectric sensor.

5. The electronic cowbell of claim 1, wherein the main holder is made of a plastic material, a die-cast material, or a steel plate.

6. The electronic cowbell of claim 1, wherein the elastic pad is made of rubber, silicone, plastic, or a combination thereof.

7. The electronic cowbell of claim 1, wherein the back cover is made of a plastic material, a die-cast material, or a steel plate.

8. The electronic cowbell of claim 1, wherein the back cover comprises one or more holes that reduce generation of resonance sound in response to percussion of the main holder.

9. The electronic cowbell of claim 1, further comprising:
a circuit board electrically connected to the first sensor and the second sensor; and
a circuit board holder on which the circuit board is disposed.

10. The electronic cowbell of claim 9, wherein the circuit board holder is mounted on the main holder.

11. The electronic cowbell of claim 9, wherein the circuit board holder is made of a plastic material.

12. The electronic cowbell of claim 1, further comprising:
a shaft holder coupled to the main holder, the shaft holder comprising one or more holes;
a fixing screw comprising a loop; and
a wing nut configured to secure the shaft holder between the fixing screw and the wing nut,
wherein the fixing screw and shaft holder are configured to install the electronic cowbell on a shaft with the shaft traversing through the loop of the fixing screw and the one or more holes of the shaft holder.
